(19) United States
(12) Patent Application Publication
(10) Pub. No.: US 2019/0240924 A1
(43) Pub. Date: Aug. 8, 2019

(54) POST PROCESSING ARRANGEMENT FOR SHAPED BODIES MANUFACTURED ADDITIVELY BY PHOTOPOLYMERIZATION

(71) Applicant: Ivoclar Vivadent AG, Schaan (LI)

(72) Inventor: John HENDRIK, Buchs (CH)

(21) Appl. No.: 16/267,510

(22) Filed: Feb. 5, 2019

(30) Foreign Application Priority Data
Feb. 6, 2018 (EP) 18155329.8

(51) Int. Cl. B29C 67/00; B33Y 30/00

(52) U.S. Cl. CPC B29C 67/00; B29C 70/00; B33Y 30/00

(57) ABSTRACT

The present invention relates to a post processing arrangement for shaped bodies manufactured additively by photopolymerization, which has a cleaning station for cleaning and a finishing station for post-exposure of the shaped body, characterized in that the cleaning station and the finishing station are housed in a housing (2), capable of standing on a horizontal stand surface, in which the cleaning station (22) is housed in a lower section (20) and the finishing station (42) is housed in an upper section (40) lying vertically above it, wherein the lower and upper sections can be connected to each other by a passage with a closure (24) which can be opened, in that a vertical lifting apparatus (44) with a vertical guide (46) and a holder (48), vertically displaceable thereon, to which the shaped body (1) can be directly or indirectly secured, runs through the finishing station in order to be able to transport the shaped body back and forth between cleaning station (22) and finishing station (42), in that a control apparatus (4) integrated into the housing is set up to control the operation of the lifting apparatus (44), the closure (24) and the cleaning and finishing stations such that, after the shaped body (1) has been positioned on the holder and after the closure (24) has been opened, the lifting apparatus (44) lowers the shaped body into a basin (26) of the cleaning station (22); to control the operation of the cleaning station for cleaning the shaped body; after completion of the operation of the cleaning station (22), to displace the shaped body (1) upwards into the finishing station (42) using the lifting apparatus (44); to close the closure (24) of the passage and then to control the operation of the finishing station (24) for the post-exposure.

### CROSS-REFERENCE TO RELATED APPLICATIONS

This application claims priority to European patent application No. 18155329.8 filed on Feb. 6, 2018, the disclosure of which is incorporated herein by reference in its entirety.

### FIELD OF THE INVENTION

The present invention relates to a post processing arrangement for shaped bodies manufactured additively by photopolymerization which has a cleaning station for cleaning the shaped body and a finishing station for post-exposure of the shaped body.

### BACKGROUND

There are now many procedures for manufacturing a shaped body from liquid, photopolymerizable material using stereo-lithography-based additive manufacturing (Rapid Prototyping) by location-selective exposure of successive layers. A layer of viscous, liquid material is defined on a construction platform and the layer is polymerized by location-selective exposure by an exposure unit in an exposure region with a contour predefined for the respective layer. Then a further layer of photopolymerizable material is defined on the polymerized layer and this last-defined layer is polymerized by exposure with a contour predefined for this last-defined layer. The two last-named steps are repeated until a shaped body with a predefined shape is formed by the sequence of cured layers with contours predefined in layers.

Such a method for manufacturing a shaped body is known for example from WO 2010/045950 A1, which relates in particular to the manufacture of dental restorations from liquid, photopolymerizable materials. In the known method a construction platform is held vertically movable above a tank bottom which is transparent. There is an exposure unit underneath the tank bottom. The construction platform is initially lowered into the photopolymerizable material until only one layer of photopolymerizable material with the desired layer thickness remains between the construction platform and the tank bottom. This layer is then exposed with a predefined contour by the exposure unit and thereby cured. After the construction platform has been raised, photopolymerizable material is newly fed from the surroundings and the construction platform is lowered again, wherein the lowering is controlled such that the distance between the last-formed layer and the tank bottom defines a layer with the desired thickness. Thereafter, the last steps are repeated until a shaped body with the desired shape is produced by the sequential curing of layers with in each case a predefined contour.

After the polymerization of the last layer, the shaped body is removed from the manufacturing device by detaching the construction platform from a holder in the manufacturing device and removing it with the shaped body adhering thereto. In this phase the shaped body is still moist, i.e. wetted by liquid, photopolymerizable material. Furthermore, there can still be areas in the shaped body with incompletely polymerized material. The removed shaped body is therefore subjected to post processing for cleaning and finishing by post-exposure. For this the process is, for example, as follows in the state of the art, wherein the preamble of claim 1 relates to such post processing arrangement. The construction platform with the shaped body suspended thereon is pushed into a holder frame and this is then dipped into a first cleaning tank with isopropanol for coarse cleaning. The isopropanol bath is set in motion by magnetic stirrers in order to detach still adhering, unpolymerized material from the surface of the shaped body. After this coarse cleaning, the holder frame is removed from the cleaning tank and dipped into a second, separate cleaning tank for fine cleaning. Here too, the cleaning is aided by magnetic stirrers. Alternatively, ultrasound is also used as actuator, which is, however, very controversial and not recommended when handling solvents directly for health and safety reasons. The holder frame is then raised out of the second cleaning basin, and the shaped body is subsequently blown with pressurized air in order to remove the isopropanol with dissolved photopolymer and to dry the shaped body. Finally, the holder frame with the shaped body suspended thereon on the construction platform is placed in a separate finishing device and there subjected to a post-exposure in order to polymerize still unpolymerized residues in the shaped body. The handling of the construction platform held in the holder frame with the shaped body, as well as the transport thereof into and between the cleaning tanks and to the finishing device, is effected manually. The setting of the magnetic stirrers, the control of the cleaning durations in the two cleaning tanks as well as the setting of the operating parameters of the finishing device are also likewise effected manually by an operator. The operator must be protected with gloves in order not to come into contact with the moist shaped body or the cleaning liquids. Other system providers recommend removing the shaped bodies from the construction platform before the cleaning and finishing, wherein the shaped bodies themselves have to be touched/gripped and handled individually. This previously described post processing arrangement on the one hand requires a lot of space (two side-by-side cleaning tanks and a further post-processing device next to them) and on the other hand is personnel-intensive as the handling and the transport of the shaped body held in the holder frame has to be effected manually by personnel, who also have to set the operating parameters manually during the cleaning and during the finishing. The post processing in such a post processing arrangement is therefore personnel-intensive and error-prone as incorrect settings during the cleaning and during the finishing can result.

Besides, there is also already a post processing arrangement in which the two cleaning tanks are held side-by-side by a frame, with the result that the two cleaning tanks can be handled as a unit. However, the problem of the large amount of space required is not alleviated thereby, since the two tanks are arranged side-by-side and in this respect occupy a large surface area. Moreover, the finishing device, as a separate device, also occupies further space. The problems of the implementing steps of the finishing being personnel-intensive and the selection and setting of the correct implementing steps being error-prone are also not addressed thereby.

A post processing arrangement for shaped bodies generated by 3D printers is known from US 2016/0107392 A1. In the post processing arrangement there are a single or several independent post processing devices. Devices for applying paint or for surface finishing by abrasives are named as post processing devices. The post processing device or devices and the 3D printer are connected to a communication unit which sends the 3D object information for controlling the 3D printer to the latter and sends post processing information to the post processing device or devices, which then automatically carry out the post processing operations on the basis of this information. In the case of several post processing devices, the shaped body to be finished is transported manually between the post processing devices or automatically by an automatic transport apparatus. The post processing processes of cleaning by liquid cleaning agent and finishing by post-exposure are not mentioned in the document.

### SUMMARY

The object of the present invention is to design a post processing arrangement for shaped bodies manufactured additively by photopolymerization, which is set up for the post processing steps of the cleaning of the shaped body in a liquid cleaning agent and the finishing by post-exposure, such that it has a compact, space-saving structure and is convenient for the user and can be operated safely to carry out the post processing.

The post processing arrangement with the features of claim 1 serves to achieve this object. Advantageous embodiments of the invention are listed in the dependent claims.

According to the invention the post processing arrangement is designed such that the cleaning station and the finishing station are housed in a housing capable of standing on a horizontal stand surface, in which housing the cleaning station is located in a lower section and the finishing station in an upper section lying vertically above it. The lower and the upper sections are connected to each other by a passage with a closure which can be opened. Extending through the finishing station is a vertical lifting apparatus with a vertical guide and a holder, vertically displaceable thereon, to which the shaped body can be directly or indirectly attached in order to be able to transport the shaped body out of the finishing station into the cleaning station and back again. A control apparatus integrated into the housing is set up to control the operation of the lifting apparatus, the closure and the cleaning and finishing stations such that, after the shaped body has been positioned on the holder and after the closure has been opened, the lifting apparatus lowers the shaped body into a basin of the cleaning station; to control the operation of the cleaning station for cleaning the shaped body; after completion of the operation of the cleaning station, to displace the shaped body upwards into the finishing station using the lifting apparatus; to close the closure of the passage and then to control the operation of the finishing station for the post-exposure.

The integration of the cleaning station and the finishing station in a relationship such that they lie vertically one above the other in a housing allows a particularly space-saving and compact structure. It is particularly advantageous to house the cleaning station underneath the finishing station lying above it as, in such a structure, the shaped body can be lowered using the lifting apparatus from above into the basin, which is open at the top, in order then to carry out the cleaning steps. After completion of the cleaning steps, the shaped body is moved by the control apparatus by operation of the lifting apparatus automatically upwards into the finishing station, where the control apparatus then starts and controls the operation of the finishing station for the post-exposure of the shaped body after the closure has been closed. The arrangement of cleaning station and finishing station vertically one above the other in a housing capable of standing makes it possible to house the post processing arrangement on a very small footprint, with the result that this can be installed in a space-saving manner.

Furthermore, an operator only has to bring the constructed shaped body into connection with the holder on the lifting apparatus once, e.g. connect the construction platform with one or more shaped bodies to the holder, after which the finishing steps of cleaning and post-exposure proceed automatically under the control of the control apparatus, with the result that over this time the operator no longer needs to intervene and no longer comes into contact with the shaped body, and can thus turn to other tasks during this time.

In a preferred embodiment, the lifting apparatus is provided with a rotary drive. The holder is connected to the rotary drive and designed such that the shaped body can be set in rotation about a vertical axis by the rotary drive in order to clean the shaped body by centrifuging of photopolymerizable liquid. An effective, contactless removal of residues of photopolymerizable liquid can be effected by rapid rotation about their own vertical axis. This cleaning step is effected after the control apparatus has actuated the lifting apparatus to displace the shaped body on the holder downwards into the empty basin of the cleaning station, whereupon the rotary drive is started by the control apparatus in order to carry out the cleaning step. The centrifuged residues of photopolymerizable liquid are collected in the basin and therefore do not lead to contamination of the post processing arrangement.

In an alternative preferred embodiment, the cleaning station is provided with a controllable feed for cleaning liquid. The control apparatus is set up to control the operation of the cleaning station, after the shaped body has been lowered into the basin by the lifting apparatus, by filling the basin with cleaning liquid for cleaning the shaped body. The cleaning action can be intensified by magnetic stirrers which are set in rotation on the bottom of the basin in order to set the cleaning liquid in motion. Alternatively, the lifting apparatus can be provided with a rotary drive and the holder can be mounted rotatably on the vertical guide and connected to the rotary drive, with the result that the shaped body can be set in rotation by the rotary drive. After the shaped body has been lowered into the basin with cleaning liquid by the lifting apparatus, the control apparatus can start the rotary drive in order thus to set the shaped body in rotation in the cleaning liquid and thereby intensify the cleaning action.

In an advantageous embodiment, the post processing arrangement is designed for connection of at least two containers with cleaning liquid. For this, for example in the area of the cleaning station, connection fittings for hoses can be provided which are connected to containers with cleaning liquid. Furthermore, in the post processing arrangement, pump and valve apparatuses are provided which, under the control of the control apparatus, selectively pump cleaning liquid from a particular container into the basin of the cleaning station and, after completion of the cleaning step with this cleaning liquid, pump this out of the basin, wherein the cleaning liquid is then in most cases pumped back into the container from which it was removed. After the cleaning with one cleaning liquid, the control apparatus, as required by a cleaning program stored therein, by control of the pump and valve apparatuses, can pump another cleaning liquid from another selected container with cleaning liquid into the basin of the cleaning station, carry out a further cleaning step and then pump the cleaning liquid away again. For example a coarse and then a fine cleaning can thus be carried out. In order to cause the cleaning liquid to flow and thereby increase the cleaning action, a magnetic stirrer or alternatively an ultrasonic actuator is arranged on the basin bottom.

In this way it is possible to carry out several cleaning steps with different cleaning liquids (chemically the cleaning liquids can have the same basic form, but contain different proportions of contaminations by photopolymerizable material from preceding cleaning processes) in a single basin, which requires much less space than the side-by-side cleaning tanks with the respective cleaning liquids present in the state of the art.

In an advantageous embodiment, the finishing station is provided with at least two light sources for the post-exposure of the shaped body with different wavelengths, preferably with at least four light sources for post-exposure with four different wavelengths. In an advantageous embodiment, the four light sources are selected such that their maximum wavelengths lie in the ranges 360-370 nm, 380-390 nm, 400-410 nm and 455-465 nm.

In an advantageous embodiment, the control apparatus is connected to a input apparatus for receiving information about the properties of the shaped body to be finished. The control apparatus furthermore has a memory, in which operating programs for the cleaning station and the finishing station as a function of information on the properties of the shaped body are stored. The control apparatus is set up to retrieve the associated operating programs for the cleaning station and the finishing station after the information about the properties of the shaped body has been received, and to control the cleaning station and the finishing station as required by the retrieved operating programs. The input apparatus can be a manual input apparatus on the post processing arrangement, which is designed for the manual input of information about the properties of the shaped body by a user. The input apparatus can comprise, for example, a keyboard or a touchscreen.

Alternatively, the input apparatus comprises a reading apparatus, which is designed to read a data storage medium connected to the construction platform or the shaped body or assigned to the latter with information about the properties of the shaped body. For example, the data storage medium is an RFID transponder connected to the construction platform, which contains information about the shaped body manufactured on the construction platform. The information about the shaped body can comprise its geometric properties, construction materials used and construction parameters such as exposure times, etc. Alternatively, the data storage medium can be a barcode or Data Matrix code, which is applied to the construction platform or integrated in the shaped body and which is detected by a reader and transmitted to the post processing arrangement before the construction platform is connected to the holder of the lifting apparatus.

In an advantageous embodiment, the lifting apparatus and its holder are designed such that a shaped body is held on the holder such that the shaped body hangs down and is freely accessible from all sides and from below. In this way, the lifting apparatus can lower the shaped body into the basin of the cleaning station.

In a preferred embodiment, the lifting apparatus and its holder are designed in order that a construction platform with the shaped body or bodies adhering thereto can be connected to the holder, with the result that the shaped body is suspended on the construction platform pointing downwards and is freely accessible underneath the holder, i.e. there is free access to the shaped bodies at least over the lower hemisphere underneath the construction platform for the radiation of the finishing station and the cleaning liquid of the cleaning station. In this embodiment, after completion of the construction process on the construction platform, the shaped body, adhering to the latter, is removed from the manufacturing device and then inserted, with the construction platform, into the post processing arrangement. Inserting the construction platform with the shaped bodies suspended thereon into the post processing arrangement, without having to remove the shaped bodies from the construction platform in preparation for the cleaning and post-exposure, simplifies the handling during the finishing process. The lifting apparatus can lower the construction platform towards the basin until the lower edge area of the construction platform also comes into contact with cleaning liquid. This has the advantage that the part of the construction platform which is wetted with uncured photopolymerizable liquid is also automatically cleaned.

In a preferred embodiment, the housing unit consisting of lower and upper sections is cylindrical, preferably in the shape of a circular cylinder, or prism-shaped.

In a preferred embodiment, the upper section of the housing, in which the finishing station is housed, is provided in its outer wall with a flap that can be opened and closed, and which, once opened, allows access to the interior of the exposure station for loading and removing a shaped body to be finished, or a construction platform including the shaped body.

In a preferred embodiment, the upper section and the lower section of the housing unit are detachably connected to each other. This means that the finishing station in the upper section and the cleaning station in the lower section can each be formed as modules which can be connected to each other lying vertically one above the other and which each have an opening which, in the connected state of the upper and lower sections, aligned with each other, form the passage for vertically transporting the shaped body between the stations, which is attached to the holder or connected to the holder via the construction platform attached to the holder. The closure for selectively opening and closing the passage is then arranged at the opening in the upper wall of the lower section.

In a preferred embodiment, the control apparatus is housed in a detachable third section of the housing. The upper and lower sections, which can be detached from each other, and the third section of the housing are designed such that the third section with the control apparatus can be attached to the lower section underneath the latter. There are electrical connections which connect the control apparatus to the cleaning station and the finishing station. The upper section can also be designed such that the upper section can also be placed on the third housing section when the upper section is detached from the lower section. In this embodiment, it is possible in principle to operate the finishing station and the cleaning station also as separate units, if a separate operation is advantageous in particular situations.

### BRIEF DESCRIPTION OF THE DRAWINGS

The invention is described below with reference to embodiment examples in the drawings, in which:

FIG. 1 shows a schematic cross-sectional view of a finishing station for the finishing station shown in FIG. 4,

FIG. 2 shows a schematic cross-sectional view of a finishing station for the finishing station shown in FIG. 4,

FIG. 3 shows a schematic cross-sectional view of a cleaning station for the post processing arrangement shown in FIG. 4,

FIG. 4 shows a schematic cross-sectional view of an embodiment of the post processing arrangement,

FIG. 5 shows a cross-sectional view of the post processing arrangement shown in FIG. 4, wherein parts that can be detached from each other have been detached from each other,

FIG. 6 shows a cross-sectional view of the post processing arrangement in three different states in the course of a post processing,

FIG. 7 shows a schematic cross-sectional view of a further embodiment of the post processing arrangement, and

FIG. 8 shows a schematic cross-sectional view of another embodiment of the post processing arrangement.

### DETAILED DESCRIPTION

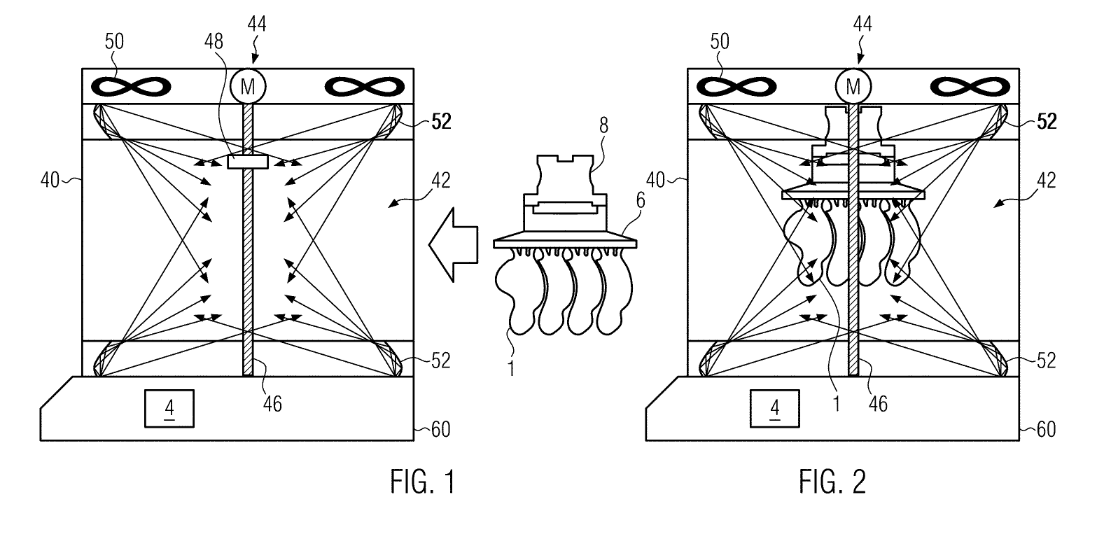

In FIGS. 1 and 2, the finishing station 42 is initially, for explanation purposes, shown detached from the cleaning station of the post processing arrangement in order to illustrate its structure and function. The finishing station 42 has a cylindrical upper housing section 40, in which, close to the upper and the lower ends, circumferential reflectors 50 are attached which reflect light in a distributed manner into an exposure region from light sources arranged distributed around the circumference. Due to the shape of the reflectors 50, the light is reflected distributed over a wide range along a central axis. The light beams, reflected in a distributed manner by the reflectors 50, of the light sources are indicated in each case by a group of arrows in FIGS. 1 and 2. Several types of light sources with different maximum emissions can be distributed around the circumference, with the result that exposures with desired wavelengths can be carried out.

On the right in FIG. 1 shaped bodies 1 are represented schematically, here in the form of dental prosthesis bases, which, after being manufactured using stereolithography, are still suspended on a construction platform 6, which has an upper extension 8 lying opposite the shaped bodies 1. The construction platform 6 has been removed from a stereolithography device after completion of the manufacturing process. The construction platform, with the shaped bodies 1 suspended thereon, is introduced into the inside of the finishing station 42 through an opening in the outer wall of the upper section 40 of the housing, which can be opened by a flap (not shown), as indicated schematically by the arrow in FIG. 1.

In the finishing station 42 there is a vertical lifting apparatus 44. This extends through the entire upper housing section 40 with a vertical guide 46, here indicated as a spindle. A holder 48 engages with the vertical guide 46 and can be displaced along thereon in the vertical direction. The construction platform 6 is designed, connected to the holder 48, to interact with the vertical guide 46 in order thus to be displaceable in the vertical direction by the lifting apparatus 44.

After the shaped bodies 1 with the construction platform 6 have been placed on the holder and thus on the vertical guide 46, the exposure of the shaped bodies 1 for their finishing could already have been carried out, as shown in FIG. 2. In a finishing station according to the invention, however, after loading of the finishing station with the construction platform 6 including shaped bodies 1, the latter is lowered into the cleaning station 22 and firstly cleaned there, as is described further below.

The finishing station 42 is provided with schematically represented fans 50, which dry the shaped bodies, after the cleaning, by a generated airflow and cool the finishing station 42 during the post-exposure. In addition, the fans guarantee that solvent vapours are discharged from the finishing station in order to prevent a possible ignition during the post-exposure.

FIGS. 1 and 2 show the upper housing section placed on a third housing section 60, in which a control apparatus 4 for controlling the different components of the post processing arrangement is housed. In this configuration, the finishing station 42 can also be operated separately. In FIG. 5, an electrical connection, which guarantees the connection of the finishing station to the control apparatus 4 if all modules are arranged one above the other and connected to each other, is indicated by a dashed line inside the cleaning station.

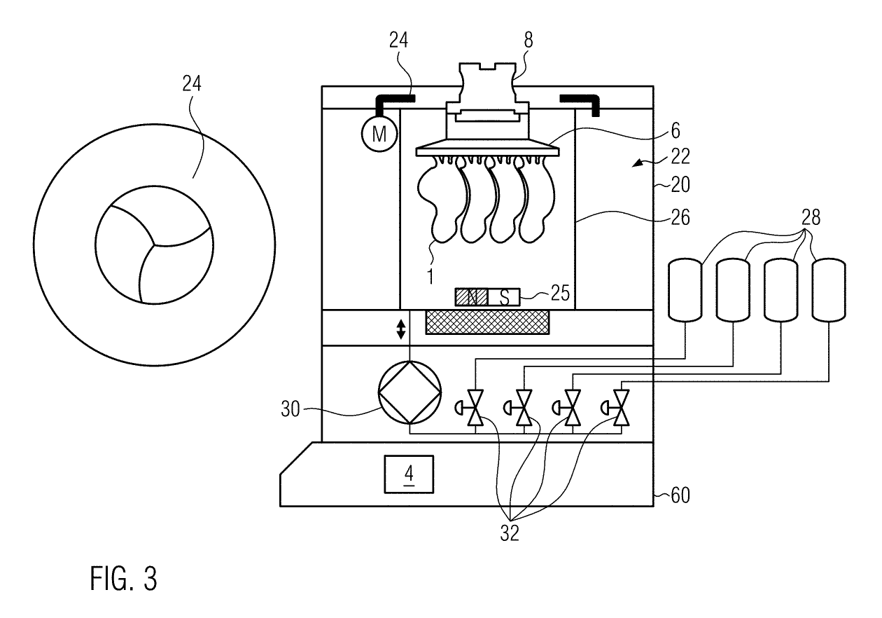

FIG. 3 now shows a cleaning station 22 initially placed in isolation on the third housing section 60 in order to explain the structure and function of the cleaning station 22. The cleaning station 22 is housed in a lower housing section 20, in a top wall of which there is an opening with a closure 24, which is represented on the left in FIG. 3 in a top view as an iris valve. The closure 24 can be opened by the control apparatus 4, after which the shaped bodies 1 on the construction platform 6, which is borne by the lifting apparatus 44 through the holder, are lowered into the cleaning station 22. The construction platform 6 is designed such that, suspended on the holder 48 of the lifting apparatus 44, it is lowered, with the shaped bodies 1, into the cleaning station 22, when the holder 48 is displaced on the vertical guide 46 downwards into the maximally lowered position.

A container or basin 26 which is open at the top is arranged in the lower housing section 20 in the cleaning station 22. The cleaning station 22 further comprises a pump 30 and a row of valves 32 connected thereto. External containers 28 with cleaning liquids can be connected to the valves 32. When the shaped bodies are located in the interior of the basin 26 lowered into the position represented in FIG. 3, the pump 30 pumps cleaning liquid from a selected one of the containers 28, which is selected by opening the valve 32 assigned to the respective container 28, into the basin 26, which is filled until the shaped bodies 1 and the lower part of the construction platform dip into the cleaning liquid. The pump 30 and the valves 32 are controlled by the control apparatus 4 in the third housing section 60.

The basin 26 is furthermore provided with a magnetic stirrer 25, which sets the cleaning liquid in motion in order to intensify the process of cleaning the shaped bodies 1 with the cleaning liquid. As an alternative to the magnetic stirrer, an ultrasonic actuator can also be arranged on the underside of the basin bottom.

After completion of a cleaning step, the pump 30 pumps the cleaning liquid back out of the basin 26, wherein the cleaning liquid a generally is pumped back into the container 28 from which it had previously been pumped into the basin 26. The cleaning liquid can thereby be re-used. Cleaning liquids of different types or of different purities can be present in the containers 28, with the result that successive cleaning steps can be carried out with different cleaning liquids by pumping in the cleaning liquids successively from particular containers 28. For example, a coarse cleaning with a first cleaning liquid from a first of the containers 28 can be carried out first and, after the cleaning liquid for the coarse cleaning has been pumped away, a cleaning liquid of higher purity from another of the containers 28 can be pumped into the basin in order to carry out a subsequent cleaning.

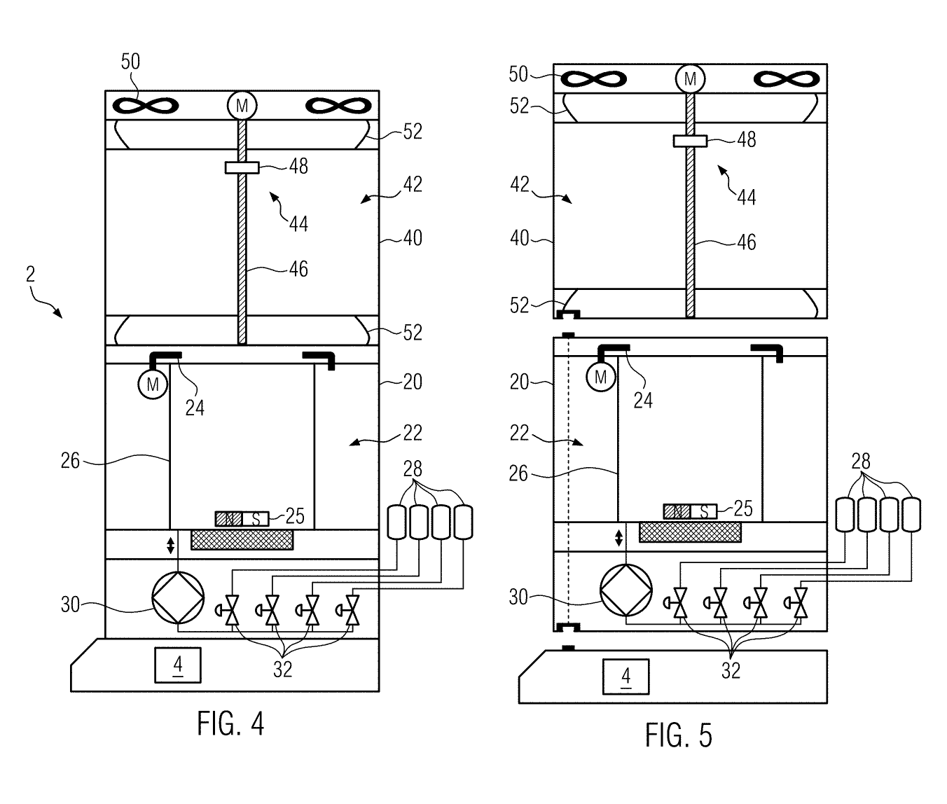

FIGS. 4 and 5 now show the complete post processing arrangement with the previously described upper housing section 40, lower housing section 20 and the third housing section 60, wherein FIG. 5 differs from FIG. 4 merely in that the named housing sections are represented therein as detachable from each other. In FIG. 5 an electrical connection, which guarantees the connection of the finishing station 42 to the control apparatus 4 when all modules are arranged one above the other, is indicated by a dashed line inside the cleaning station.

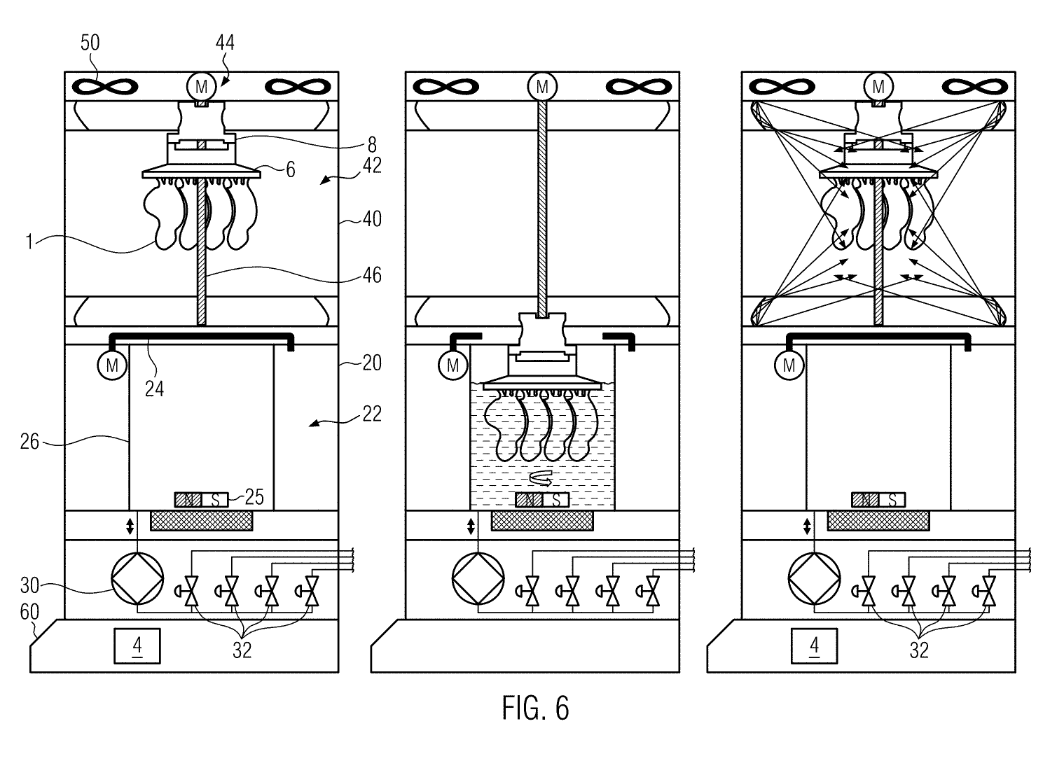

FIG. 6 shows the post processing arrangement from FIG. 4 in different states during the finishing. In the left-hand representation of FIG. 6, the construction platform 6 and the shaped bodies 1 suspended thereon in the finishing station 42 are shown suspended on the holder of the vertical lifting apparatus 44, after the shaped bodies 1 with their construction platform, after their manufacture in a stereolithography device, have thus been inserted into the finishing station 42 in the upper housing section 40. The shaped bodies 1 still wetted with photopolymerizable, uncured material then have to be subjected firstly to a cleaning. For this, the control apparatus 4 controls the lifting apparatus 44 such that the construction platform 6, placed on the holder, is displaced downwards. The control apparatus 4 opens the closure 24, which uncovers an opening of the passage between the upper housing section 40 and the lower housing section 20, with the result that the shaped bodies 1, on the construction platform 6, can pass through the passage into the cleaning station 22 in the lower housing section 20. When the shaped bodies 1 have been lowered far enough into the basin 26 of the cleaning station 22, as is shown in the centre in FIG. 6, the cleaning processes begin through the pumping-in of cleaning liquids as described above with reference to FIG. 3.

After completion of one or more cleaning steps with one or more cleaning liquids and after the last cleaning liquid has been pumped out of the basin 26, the control apparatus 4 controls the lifting apparatus 44 in order to displace the shaped bodies 1 vertically upwards again into the finishing station 42. As soon as the shaped bodies 1 are again located in the finishing station 42, the closure 24 can be closed again by the control apparatus 4. Thereafter, as is shown on the right in FIG. 6, the post-exposure can then be carried out as described in connection with FIGS. 1 and 2 by the control device 4 operating the desired light sources with the desired intensity over a desired exposure time in order to fully polymerize not yet completely cured zones of the shaped bodies 1. Finally, the construction platform 6 with the shaped bodies 1 suspended thereon can be removed from the post processing arrangement by opening the flap (not shown) in the outer wall of the upper housing section 40 and removing the construction platform 6 with the shaped bodies 1 thereon, thus concluding the finishing of the shaped bodies 1.

Between the introduction of the shaped bodies 1 to be finished into the post processing arrangement and the removal of the shaped bodies 1 after their finishing, all of the above-described finishing steps can be carried out automatically and in a controlled manner by the control apparatus 4, which allows a stored operating program to be extended. The finishing process is thereby less personnel-intensive and there are no risks of individual steps being carried out incorrectly or inadequately by the personnel, as the steps run according to predefined programs.

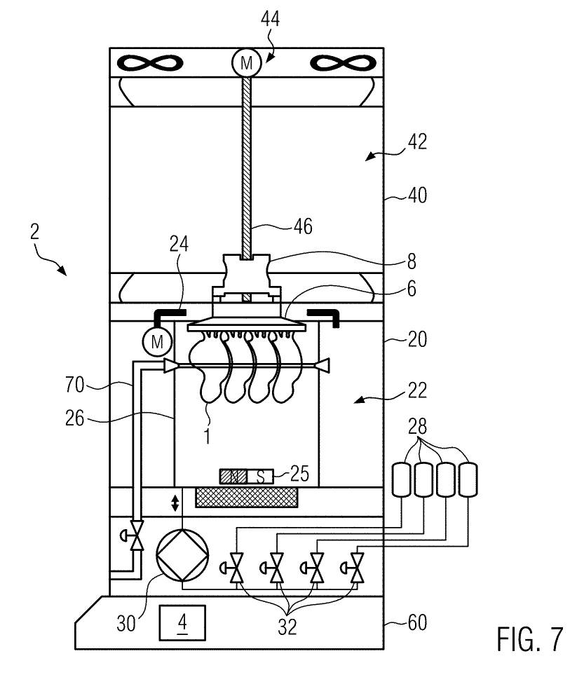

The embodiment shown in FIG. 7 differs from the previously described post processing arrangement merely in that in the embodiment according to FIG. 7 there is further a compressed-air line 70 which discharges into a plurality of nozzles. The compressed-air line can be connected to an external compressed-air source. The control apparatus 4 is set up to guide the shaped bodies 1 vertically past the nozzles using the lifting apparatus after completion of the cleaning process in order to blow away still adhering cleaning liquid by means of compressed air and thus to improve the cleaning and drying process of the shaped body. In a preferred embodiment, there can also be only one air nozzle, which is formed as an airknife, i.e. the nozzle opening is formed as an elongate nozzle gap. An annular airknife, in which the nozzle gap is directed annularly onto the inside of the annular airknife, is particularly preferred. Airflow can thereby be directed from all sides onto the shaped body moved through the annular opening of the airknife, in order to free it of residual cleaning liquid and dry it particularly effectively.

In a further embodiment, located in the holder for receiving the construction platform is a rotary drive, which can allow the construction platform together with shaped bodies to rotate about the vertical axis in order to remove excess adhering cleaning agent by centrifugation, instead of by blowing.

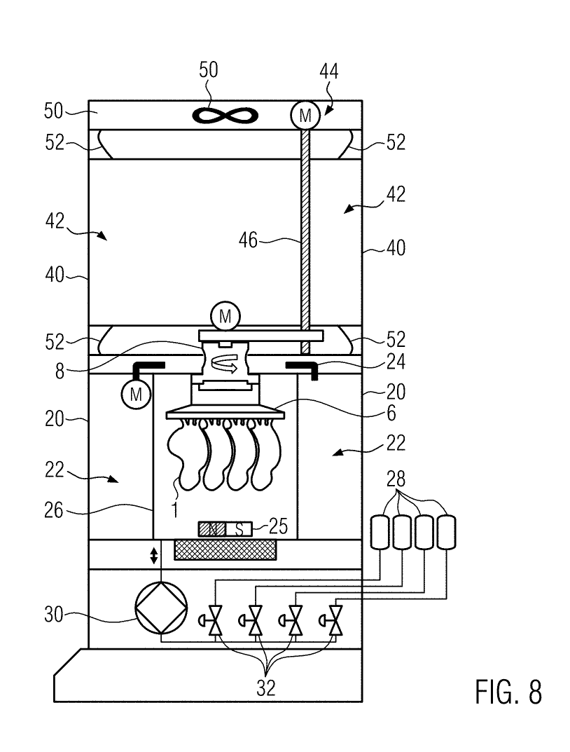

A further embodiment is shown in FIG. 8, in which the holder, which is vertically displaceable on the vertical guide 46, is provided with a rotary drive, which can set the construction platform 6 with the shaped bodies 1 thereon in rotation about the vertical axis. Through the rotation of the shaped bodies 1 against the cleaning liquid located in the basin 26 (not shown in FIG. 8), the cleaning action can be intensified by the movement of the cleaning liquid in relation to the shaped bodies. In such an embodiment with a rotatable construction platform, the magnetic stirrer 25 additionally represented in FIG. 8 is not strictly necessary. However, as in FIG. 8, it can also be used in combination with the rotary drive on the holder in order to set the cleaning liquid in a rotation counter to the rotation of the construction platform or in order to stop or reverse the rotation of the cleaning liquid in the basin 26 induced by the rotation of the construction platform.

The manner of the cleaning to be carried out and the manner of the post-exposure to be carried out can depend on properties of the shaped bodies to be finished. For example, the selection of both the wavelengths and the intensities of the post-exposure to be carried out can depend on the size, the shape and the type of material of the shaped body and on the type of photopolymer which was used to produce the shaped body. The cleaning steps to be performed can likewise depend on properties of the shaped body to be finished in the specific case. For these reasons, the post processing arrangement is advantageously connected to an input apparatus for receiving information about the properties of the shaped body to be finished. The input apparatus can be part of the post processing arrangement. Furthermore, the control apparatus is provided with stored operating programs for the cleaning station and the finishing station and is set up to select, as a function of the information about the properties of the shaped body to be post-processed, a stored operating program for the cleaning station and the finishing station which is suitable for the properties of the shaped body to be post-processed. The operating program selected according to the shaped bodies specifically to be post-processed as determined by the information about its properties can then run fully automatically in the post processing arrangement controlled by the control apparatus 4, without the need for intervention by personnel.

The input apparatus for the information about the properties of the shaped body can be a manual input apparatus for the manual input of the information about the properties of the shaped body by a user. Alternatively, an automatic reading apparatus can act as the input apparatus, which is set up to read a data storage medium connected to the shaped body or assigned to it with the information on the properties of the shaped body. For example, a data storage medium in the form of a barcode or a Data Matrix code can be attached to the upper side of the construction platform 6 facing away from the shaped bodies 1 or can itself be part of the shaped body and contain information about the manufactured shaped bodies 1 suspended thereon, which can be read by a code reader as input apparatus, in order then to use the information on the shaped bodies 1 for the automatic selection of an operating program suitable therefore from the memory of the control apparatus 4 and to allow the selected operating program then to be executed in the post processing arrangement.

1. A post processing arrangement for shaped bodies manufactured additively by photopolymerization comprising
a cleaning station for cleaning a shaped body and
a finishing station for post-exposure of the shaped body,
wherein the cleaning station and the finishing station are housed in a housing (2), configured to stand on a horizontal stand surface,
wherein the cleaning station (22) is housed in a lower section (20) and the finishing station (42) is housed in an upper section (40) disposed vertically above the lower section,
wherein the lower and upper sections are connected to each other by a passage with a closure (24) which can be opened,
wherein a vertical lifting apparatus (44) with a vertical guide (46) and a holder (48), vertically displaceable thereon, to which the shaped body (1) can be directly or indirectly secured, extends through the finishing station in order to be able to transport the shaped body back and forth between cleaning station (22) and finishing station (42),
wherein a control apparatus (4) integrated into the housing is configured to control the operation of the lifting apparatus (44), the closure (24) and the cleaning and finishing stations such that, after the shaped body (1) has been positioned on the holder and after the closure (24) has been opened, the lifting apparatus (44) lowers the shaped body into a basin (26) of the cleaning station (22);
wherein the control apparatus is configured to control the operation of the cleaning station for cleaning the shaped body; after completion of the operation of the cleaning station (22), to displace the shaped body (1) upwards into the finishing station (42) using the lifting apparatus (44); to close the closure (24) of the passage and then to control the operation of the finishing station (24) for the post-exposure.

2. The post processing arrangement according to claim 1,
wherein the lifting apparatus (44) is provided with a rotary drive and the holder is connected to the rotary drive and designed such that the shaped body (1) can be set in rotation about a vertical axis by the rotary drive in order to clean the shaped body by centrifuging of photopolymerizable liquid.

3. The post processing arrangement according to claim 1,
wherein the cleaning station (22) is provided with a controllable feed for cleaning liquid and
wherein the control apparatus (4) is set up to control the operation of the cleaning station (22), by filling the basin (26) with cleaning liquid for cleaning the shaped body (1).

4. The post processing arrangement according to claim 3,
wherein the lifting apparatus (44) is provided with a rotary drive and the holder is connected to the rotary drive and designed such that the shaped body (1) can be set in rotation about a vertical axis by the rotary drive, and wherein the control apparatus (4) is set up to set the shaped body in rotation in the cleaning liquid using the rotary drive after the basin (26) has been filled with cleaning liquid in order to intensify the cleaning action.

5. The post processing arrangement according to claim 3,
wherein the post processing arrangement is designed for connection of at least two containers (28) with cleaning liquid and is provided with a pump (30) and valve apparatuses (32), which, under the control of the control apparatus (4), selectively pump cleaning liquid from a container (28) into the basin (6) and, after completion of the cleaning, out of the basin.

6. The post processing arrangement according to claim 1,
wherein the finishing station (42) is provided with at least two light sources for post-exposure with different wavelengths.

7. The post processing arrangement according to claim 6,
wherein the finishing station (42) is provided with at least four light sources for the post-exposure of the shaped body with four different wavelengths.

8. The post processing arrangement according to claim 7,
wherein in the finishing station (42) the light sources direct light with maximum wavelengths in the ranges 360-370 nm, 380-390 nm, 400-410 nm and 455-465 nm onto the shaped body.

9. The post processing arrangement according to claim 1,
wherein the control apparatus (4) is connected to an input apparatus for receiving information about the properties of the shaped body to be finished and is provided with a memory,
wherein in the control apparatus operating programs for the cleaning station (22) and the finishing station (42) as a function of information on the properties of the shaped body are stored, and
wherein the control apparatus is set up to retrieve the associated operating programs after the information about the properties of the shaped body has been received, and to control the cleaning station (22) and the finishing station (42) as required by the retrieved operating programs.

10. The post processing arrangement according to claim 9,
wherein the input apparatus is a manual input apparatus for the manual input of information about the properties of the shaped body by a user.

11. The post processing arrangement according to claim 9,
wherein the input apparatus comprises an automatic reading apparatus which is designed to read a data storage medium connected to the shaped body or assigned to it with information on the properties of the shaped body.

12. The post processing arrangement according to claim 1,
wherein the lifting apparatus (44) and the holder (48) are designed such that a shaped body (1) is held suspended downwards such that it is freely accessible to the radiation of the finishing station and the cleaning liquid of the cleaning station at least from the entire lower hemisphere.

13. The post processing arrangement according to claim 12,
wherein the lifting apparatus (44) and the holder (48) are designed in order that a construction platform (6, 8) with the shaped body (1) adhering thereto can be attached to the holder, wherein the shaped body is suspended on the construction platform (6, 8) pointing downwards.

14. The post processing arrangement according to claim 1,
wherein the housing (2) is in the shape of a cylinder or prism.

15. The post processing arrangement according to claim 1,
wherein the upper section (40) of the housing, in which the finishing station (42) is housed, has an outer wall a flap to be opened, which allows access, when opened, to the interior of the finishing station to connect a shaped body to be finished to the holder (48) of the lifting apparatus (44) and to remove a finished shaped body from it.

16. The post processing arrangement according to claim 1,
wherein the upper section (40) and the lower section (20) of the housing (2) are detachably connected to each other.

17. The post processing arrangement according to claim 15,
wherein a bottom wall of the upper section (40) has an opening and a top wall of the lower section (20) has an opening that is flush with the opening of the bottom wall in the upper section, wherein the openings together form the passage and the closure (24) is arranged at the opening in the top wall of the lower section for the selective opening and closing of the passage.

18. The post processing arrangement according to claim 16,
wherein the control apparatus is housed in a detachable third section (60) of the housing,
wherein the lower section (20) and the third section of the housing are designed such that the third section (60) can be attached to the lower section (20) underneath the lower section and an electrical connection is disposed between the control apparatus (4) in the third section (60) and the lower and upper sections (20, 40).
